(19) United States
(12) Patent Application Publication
(10) Pub. No.: US 2011/0302149 A1
(43) Pub. Date: Dec. 8, 2011

(54) IDENTIFYING DOMINANT CONCEPTS ACROSS MULTIPLE SOURCES

(75) Inventors: VISWANATH VADLAMANI, Sammamish, WA (US); TAREK NAJM, KIRKLAND, WA (US); ABHINAI SRIVASTAVA, SEATTLE, WA (US); MUNIRATHNAM SRIKANTH, REDMOND, WA (US); ARUNGUNRAM CHANDRASEKARAN SURENDRAN, SAMMAMISH, WA (US); RAJEEV PRASAD, BOTHELL, WA (US)

(73) Assignee: MICROSOFT CORPORATION, REDMOND, WA (US)

(21) Appl. No.: 12/795,238

(22) Filed: Jun. 7, 2010

(51) Int. Cl. G06F 17/30

(52) U.S. Cl. 707/711; 707/730; 707/805; 707/E17.045; 707/E17.084; 707/E17.108

(57) ABSTRACT

Systems, methods, and computer-storage media for identifying dominant concepts are provided. The system includes a search engine connected to various sources, an entity extraction component, a metabase, and a ranking component. The search engine receives a contextual query and provides results in response to the contextual query. The entity extraction component parses the results and identifies entities included in the results. The metabase provides a distance between the entities included in the results and the query terms included in the contextual query. The ranking component ranks the entities based on the provided distance and selects dominant concepts within the results based on the ranks assigned to entities.

### BACKGROUND

Conventional search engines receive queries from users and locate web pages having terms that match the terms included in the received queries. Conventionally, the search engines ignore the context and meaning of the user query and treat the query as a set of words. The terms included in the query are searched for based on frequency, and results that include the terms of the query are returned by the search engine. Accordingly, conventional search engines return results that might fail to satisfy the interests of the user.

The conventional search engines may display a set of popular terms that a user may employ to formulate a query. The popular terms are words that users provide the search engine when searching for an item. The popular terms may be displayed in a hot topics section on a web page for the search engine. A user may click on the popular terms listed in the hot topics section to issue a query with the selected popular term.

Some conventional search engines also display tag clouds that list terms that reoccur across all items on a network, such as the Internet. The tag clouds provide a snapshot of the words that are being used within items available on the Internet. The terms in the tag cloud may be displayed in a cluster on a web page for the search engine. And a user may click on the terms listed in the tag cloud to issue a query with the selected term.

Unfortunately, the conventional search engines fail to provide a broad overview of the major concepts that are encapsulated within the results provided in response to a user's query. Rather, in response to the user's query the conventional search engines return a collection of items that include the terms of the query. The user must then peruse the collection to determine the broad concepts represented in the collection of documents.

### SUMMARY

Embodiments of the invention relate to systems, methods, and computer-readable media for identifying dominant concepts across multiple sources. The dominant concepts are extracted from results generated by a search engine that received a contextual query. The dominant concepts are displayed to provide a broad overview of major concepts encapsulated within the results.

The search engine may execute a computer-implemented method to identify the dominant concepts across various sources. The search engine receives a contextual query from the user. In turn, the search engine searches the various sources to generate a collection of results that match the contextual query. The entities within the results are extracted, by the search engine, based on appearance frequency and ranked based on contextual attributes associated with the contextual query. A subset of the extracted entities with ranks above a threshold is provided, from the search engine, as dominant concepts for the received contextual query.

This summary is provided to introduce a selection of concepts in a simplified form that are further described below in the detailed description. This summary is not intended to identify key features or essential features of the claimed subject matter, nor is it intended to be used as an aid in isolation to determine the scope of the claimed subject matter.

### BRIEF DESCRIPTION OF THE DRAWINGS

Illustrative embodiments of the invention are described in detail below with reference to the attached drawing figures, which are incorporated by reference herein, wherein:

FIG. 1 is a block diagram illustrating an exemplary computing device in accordance with embodiments of the invention;

FIG. 2 is a network diagram illustrating exemplary components of a computer system configured to identify dominant concepts in accordance with embodiments of the invention;

FIG. 3 is a screenshot illustrating a graphical user interface displaying dominant concepts in accordance with embodiments of the invention;

FIG. 4 is another screenshot illustrating a graphical user interface displaying dominant concepts and providing access to relationships between the dominant concepts and the contextual query in accordance with embodiments of the invention;

FIG. 5 is a logic diagram illustrating a computer-implemented method for identifying dominant concepts in accordance with embodiments of the invention; and

FIG. 6 is another logic diagram illustrating a computer-implemented method for identifying relationships between the dominant concepts and the query terms in accordance with embodiments of the invention.

### DETAILED DESCRIPTION

This patent describes the subject matter for patenting with specificity to satisfy statutory requirements. However, the description itself is not intended to limit the scope of this patent. Rather, the inventors have contemplated that the claimed subject matter might also be embodied in other ways, to include different steps or combinations of steps similar to the ones described in this patent, in conjunction with other present or future technologies. Moreover, although the terms “step” and “block” may be used herein to connote different elements of methods employed, the terms should not be interpreted as implying any particular order among or between various elements herein described unless and except when the order of individual elements is explicitly described.

As used herein the term “component” refers to any combination of hardware, firmware, and software.

Embodiments of the invention provide dominant concepts extracted from results associated with contextual queries received by a search engine. In one embodiment, dominant concepts in a corpus of documents included in the results are ranked and displayed to a user. The corpus of documents includes items from various sources searched by the search engine in response to the contextual queries. Relationships between the dominant concepts and the contextual queries are prioritized based on support from the corpus of documents. A user may explore the dominant concepts and snippets of documents that support the relationships between the dominant concepts and the contextual queries. Moreover, dominant concepts may be used as query terms in the search engine by clicking on the displayed dominant concepts. The graphical user interface that displays the dominant concepts may include a history view that displays recent dominant concepts accessed by the user or recent contextual queries formulated by the user.

In some embodiments, the dominant concepts within the corpus of documents may be navigated with a sparkler. The sparkler may be a graphical representation of a star that includes multiple spokes. One spoke may represent the contextual query, and the other spokes may represent the dominant concepts. In certain embodiments, the sparkler has a limited number of spokes. The limit on the number of spokes increases readability of the dominant concepts and the contextual queries displayed as part of the sparkler. The dominant concepts displayed on the sparkler are among the highest ranked dominant concepts. Accordingly, the sparkler allows a user to quickly understand the important concepts within results corresponding to the contextual query.

For instance, a search engine may provide results in response to a contextual query for “popular artist A.” The contextual query may include, among other things, the location of the user, the date the query was formulated by the user, and the application that was used to formulate the query. The results of the search engine are further processed to identify dominant concepts and relationships between the dominant concepts and the query terms. The dominant concepts for the “popular artist A” may include, but are not limited to, “popular artist B,” award events, and concert events. These dominant concepts are ranked based on distances provided by a metabase having the dominant concepts and the contextual queries. In turn, the dominant concepts with the highest ranks are selected for display on a graphical user interface with the contextual queries. The graphical user interface may display “popular artist A,” “popular artist B,” and award events on the sparkler.

The user may traverse the sparkler with a mouse or any other pointing device. When the user hovers on the “popular artist B” dominant concept, a dialog box is displayed to the user. The dialog box provides an option to issue a contextual query using the dominant concept “popular artist B” or an option to explore the relationships between the dominant concept “popular artist B” and the contextual query “popular artist A.” If the user selects the option to issue a contextual query, “popular artist B” is transmitted to the search engine for new search results. If the user selects the option to explore the dominant concept, relationships that include snippets supporting the link between “popular artist B” and “popular artist A” are displayed in priority order. The snippets may state “popular artist A and popular artist B perform in Germany,” “popular artist A and popular artist B support charity,” or “popular artist A ten spots ahead of popular artist B in top 100 singers.”

The search engine receives query terms from a user. Also, the search engine receives contexts for one or more applications that provide the queries during the current search session. The contexts and query terms are context attributes that specify a contextual query. Various data sources are searched to locate results that match to the contextual queries. The results are further processed by an entity extractor to identify entities represented in the results. In some embodiments, the entities are nouns. The extracted entities are ranked and identified as dominant concepts when a distance between the extracted entities and the contextual query is below a specified threshold.

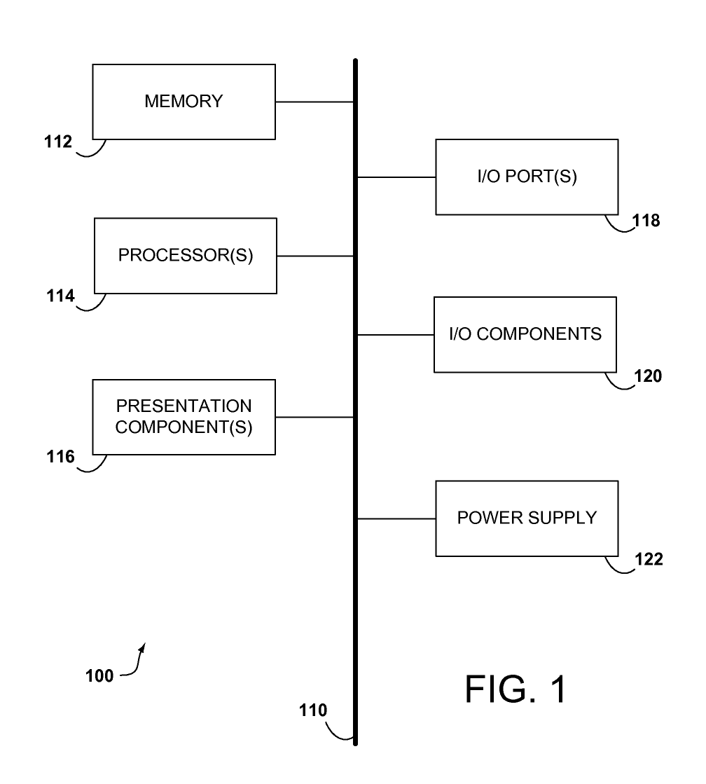

FIG. 1 is a block diagram illustrating an exemplary computing device in accordance with embodiments of the invention. The computing device 100 includes bus 110, memory 112, processors 114, presentation components 116, input/output (I/O) ports 118, input/output (I/O) components 120, and a power supply 122. The computing device 100 is but one example of a suitable computing environment and is not intended to suggest any limitation as to the scope of use or functionality of the embodiments of the invention. Neither should the computing device 100 be interpreted as having any dependency or requirement relating to any one or combination of components illustrated.

The computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that may be used to encode desired information and be accessed by the computing device 100. Embodiments of the invention may be implemented using computer code or machine-useable instructions, including computer-executable instructions such as program modules, being executed by a computing device 100, such as a personal data assistant, gaming device, or other handheld device. Generally, program modules including routines, programs, objects, modules, data structures, and the like, refer to code that performs particular tasks or implements particular abstract data types. Embodiments of the invention may be practiced in a variety of system configurations, including distributed computing environments where tasks are performed by remote-processing devices that are linked through a communications network.

The computing device 100 includes a bus 110 that directly or indirectly couples the following components: memory 112, one or more processors 114, one or more presentation components 116, input/output (I/O) ports 118, I/O components 120, and power supply 122. The bus 110 represents what may be one or more busses (such as an address bus, data bus, or combination thereof). Although the various components of FIG. 1 are shown with lines for the sake of clarity, in reality, delineating various modules is not so clear, and metaphorically, the lines would more accurately be grey and fuzzy. For example, one may consider a presentation component 116 such as a display device to be an I/O component. Also, processors 114 have memory 112. Distinction is not made between “workstation,” “server,” “laptop,” “handheld device,” etc., as all are contemplated within the scope of FIG. 1.

The memory 112 includes computer-readable media and computer-storage media in the form of volatile and/or nonvolatile memory. The memory may be removable, nonremovable, or a combination thereof. Exemplary memory hardware includes, but is not limited to, solid-state memory, hard drives, optical-disc drives, etc. The computing device 100 includes one or more processors 114 that read data from various entities such as the memory 112 or I/O components 120. The presentation components 116 present data indications to a user or other device. Exemplary presentation components 116 include a display device, speaker, printer, vibrating module, and the like. The I/O ports 118 allow the computing device 100 to be physically and logically coupled to other devices including the I/O components 120, some of which may be built in. Illustrative I/O components 120 include a microphone, joystick, game pad, satellite dish, scanner, printer, wireless device, and the like.

In some embodiments, a computer system identifies dominant concepts and relationships between the identified dominant concepts and a contextual query. The computer system includes a search engine connected to various sources, an entity extraction component, a metabase, and a ranking component. The search engine receives a contextual query and provides results in response to the contextual query. The entity extraction component parses the results and identifies entities included in the results. The metabase provides a distance between the entities included in the results and the query terms included in the contextual query. The ranking component ranks the entities based on the distance provided by the metabase and selects dominant concepts within the results based on the ranks assigned to entities. In turn, relationships between the dominant concepts and contextual queries, where the relationships include snippets that support the link between the dominant concepts and contextual queries are made available for inspection by the user.

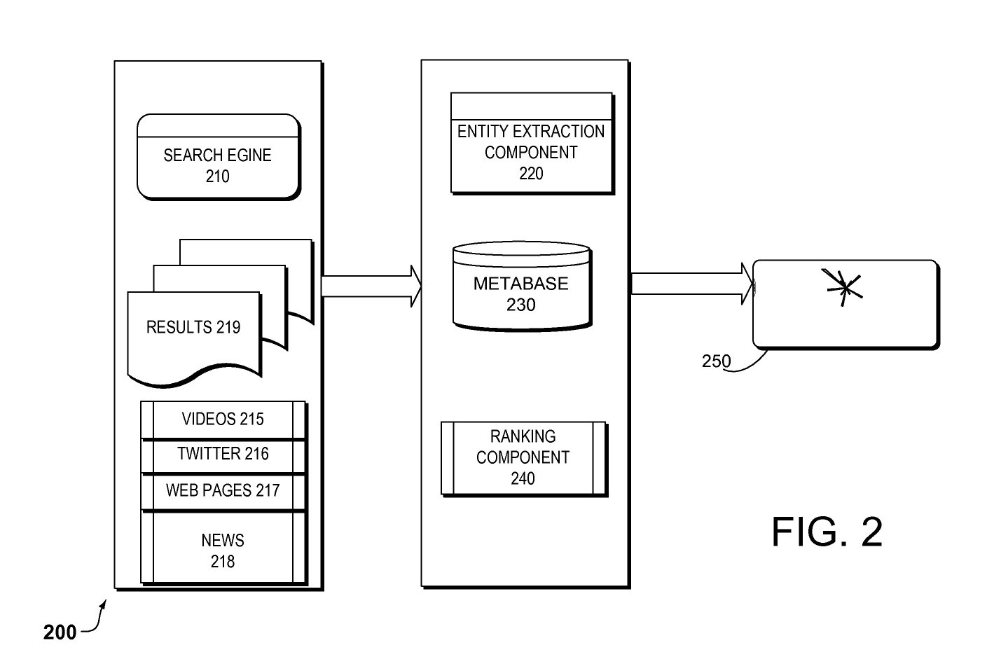

FIG. 2 is a network diagram illustrating exemplary components of a computer system 200 configured to identify dominant concepts in accordance with embodiments of the invention. The computer system 200 includes a search engine 210, entity extraction component 220, metabase 230, ranking component 240, and sparkler 250. In one embodiment, the computer system 200 may be a collection of servers communicatively connected to a client device that formulates contextual queries. In turn, the computer system 200 provides results that include items matching the contextual queries.

In certain embodiments, the search engine 210 receives the contextual queries formulated by a user. In one embodiment, the contextual query includes, among other things, query term, location, date, and application. The query term may be null or include terms provided by a user. The location may specify the physical location of the user or the device of the user. The date may specify the time and day that the user initiated the search. And the application may specify the application used to formulate the query. For instance, the application may be a pc search client, a mobile search client, etc.

The search engine 210 is communicatively connected to various sources. The sources provide access to items, such as, but not limited to, videos 215, TWITTER™ feeds 216, web pages 217, and news 218. In other embodiments, the sources may include FACEBOOK™, images, blogs, and audio. The search engine 210 traverses the sources for items that match the contextual query. The search engine 210 returns the search results 219 to the user. The search results 219 include a set of items that match the contextual query.

The entity extraction component 220 receives the search results 219 provided by the search engine. In turn, the entity extraction component 220 extracts entities included within the search results 219. In one embodiment, the entities may be nouns mentioned within the search results 219. In other embodiments, the entities may be limited to one of places, things, or persons. The entity extraction component 220 accesses extracted entities based on appearance frequency within the result set. Alternatively, the entity extraction component 220 may extract entities based on appearance frequency among the sources.

The metabase 230 is a look-up structure that provides the distance between the contextual query and the extracted entities. In one embodiment, the metabase 230 is a graph that includes nodes and edges. The nodes represent the entities and the distance between nodes is stored within each edge. The edges encapsulate relationships among the nodes. In other embodiments, the metabase is a table that is accessed to determine the distance between the contextual query and extracted entities.

The ranking component 240 receives the extracted entities and accesses the metabase 230 to retrieve the distances between the extracted entities and the contextual query stored by the metabase 230. The ranking component may include a dominant concept threshold and a relationship threshold. In certain embodiments, the dominant concept threshold and relationship threshold are predetermined and stored by the ranking component. In other embodiments, the dominant concept threshold and relationship threshold are specified by the user. The dominant concept threshold is used by the ranking component 240 to filter extracted entities whose distance from the contextual query is above the dominant concept thresholds. The remaining extracted entities may be displayed to the user to provide a broad overview of the search results. The relationship threshold is used by the ranking component 240 to select snippets from the search results 219 that support the relationship between the dominant concept and the contextual query. The snippets are ranked by the ranking component 240, which counts a number of characters or words that separate the dominant concepts from the contextual query. The snippet whose number of characters or words is below the relationship thresholds is selected by the ranking component to support the relationship between the dominant concept and the contextual query. In some embodiments, attributes of the contextual query, such as, but not limited to, location and date may be used by the ranking component 240 to prioritize the snippets. For instance, when the snippet includes a date or location that matches location or date included in the contextual query, the rank of the snippet is improved by the ranking component 240.

The sparkler 250 is a graphical user interface having a star structure. The spokes of the star display the contextual query and the identified dominant concepts related to the contextual query. The user interacts with the sparkler 250 to navigate to dominant concepts and other recent contextual queries. The user may send additional contextual queries to the search engine 210 via the sparkler 250. Additionally, the user may access the snippets that support the relationship between the contextual queries and the dominant concepts included on the sparkler 250.

In some embodiments, the dominant concepts are displayed in a graphical user interface to provide an overview of the important concepts included in results returned by a search engine in response to a contextual query. The graphical user interface may present a sparkler that is navigable to review prior contextual queries and corresponding dominant concepts. The user may use a mouse or pointer to click on, or hover over, the dominant concepts.

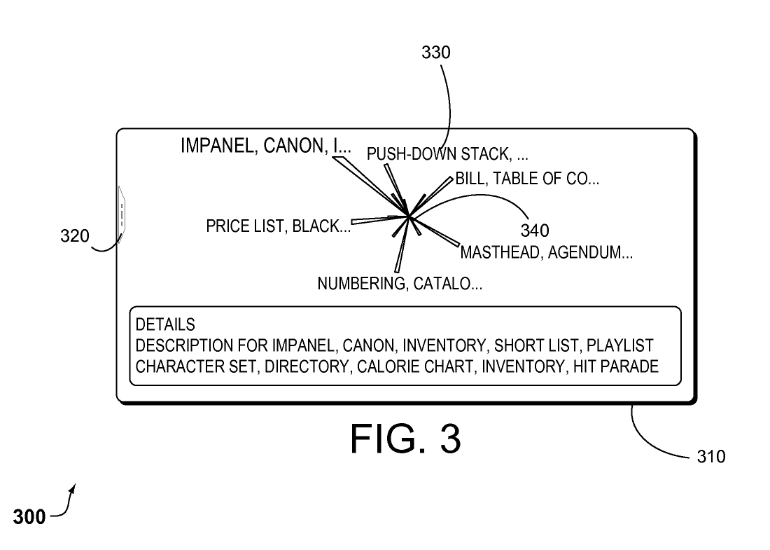

FIG. 3 is a screenshot illustrating a graphical user interface 300 displaying dominant concepts in accordance with embodiments of the invention. In one embodiment, the graphical user interface 300 includes a background 310, a navigation area 320, dominant concepts 330, and sparkler 340.

The background 310 is the area on which the dominant concepts and contextual queries are rendered for display to the user. The background 310 may include a clear color, such as white or vanilla. The background 310 may also set the boundaries for the graphical user interface 300.

The navigation area 320 allows the user to navigate the dominant concepts 330 identified by the computer system. The navigation area 320 may include a forward button and backward button, which allows the user to retrieve additional dominant concepts 330 associated with a contextual query. In at least one embodiment, the forward button and backward button may allow the user to review its search history by displaying prior contextual queries and prior dominant concepts 330 displayed by the graphical user interface 300.

The sparkler 340 is a star structure having spokes that display the contextual query and the identified dominant concepts related to the contextual query. The user interacts with the sparkler 340 to navigate to dominant concepts or to navigate to other recent contextual queries. Accordingly, the sparkler 340 provides an overview of the important concepts included in results returned by a search engine in response to contextual queries.

In another embodiment, the sparkler provides a details section and a dialog box for further interaction with the dominant concepts. The details section provides a list of metadata associated with the contextual query. The dialog box provides the option of exploring the dominant concept or issuing another search. The user interacts with the dialog box to select the option of interest to the user.

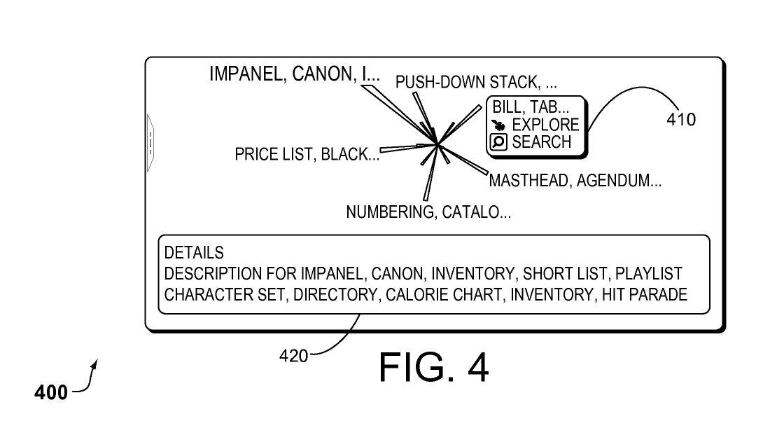

FIG. 4 is another screenshot illustrating a graphical user interface 400 displaying dominant concepts and providing access to relationships between the dominant concepts and the contextual query in accordance with embodiments of the invention. In one embodiment, the graphical user interface 400 includes a dialog box 410 and a details section 420.

The dialog box 410 includes the option of exploring the dominant concept or issuing another search. If the user chooses to explore the dominant concept, snippets that support the relationship between the dominant concept and the contextual query are displayed in priority order to the user. If the user chooses to search the dominant concepts, a contextual query specifying the dominant concept is sent to the search engine for further processing.

The details section 420 provides a description of the metadata associated with the dominant concepts or contextual query in the sparkler. The details section 420 is updated when the user clicks on the dominant concepts or the contextual query in the sparkler. For instance, clicking on the dominant concepts updates the details section with information about the clicked-on dominant concept.

In certain embodiments, the details section 420 provides the physical locations associated with the dominant concept or contextual query. The physical locations may be extracted from the contextual query or the results to the contextual query. Alternatively, the details section 420 may provide a list of uniform resource locators (URL) associated with the dominant concepts.

In some embodiments, the graphical user interface may include graphical operations, such as nearest neighbor, co-occurrence, pivots, and attribute list. The attribute list operation provides attribute information about the contextual query or a selected dominant concept. The attribute information may include author, title, and creation date of the underlying items that include the dominant concept or the contextual query. The nearest-neighbor operation provides a list of related dominant concepts. The co-occurrence operation provides words that typically occur together with the dominant concept. The pivots operations identify pivots for the dominant concepts. These operations provide dynamic views of the sparkler.

In one embodiment, the computer systems are configured to identify dominant concepts and relationships between the dominant concepts and the contextual queries and to generate a sparkler that displays the dominant concepts. The computer system receives the contextual query, scans multiple sources for items that match to generate a result set. The result set is further processed to determine entity dominance. In turn, entities are identified as dominant concepts, and snippets are selected to support the relationship between the dominant concepts and the contextual query. The snippets are prioritized based on contextual attributes included in the contextual query. And the dominant concepts and contextual queries are displayed to the user to provide an overview of the search results provided by the computer system.

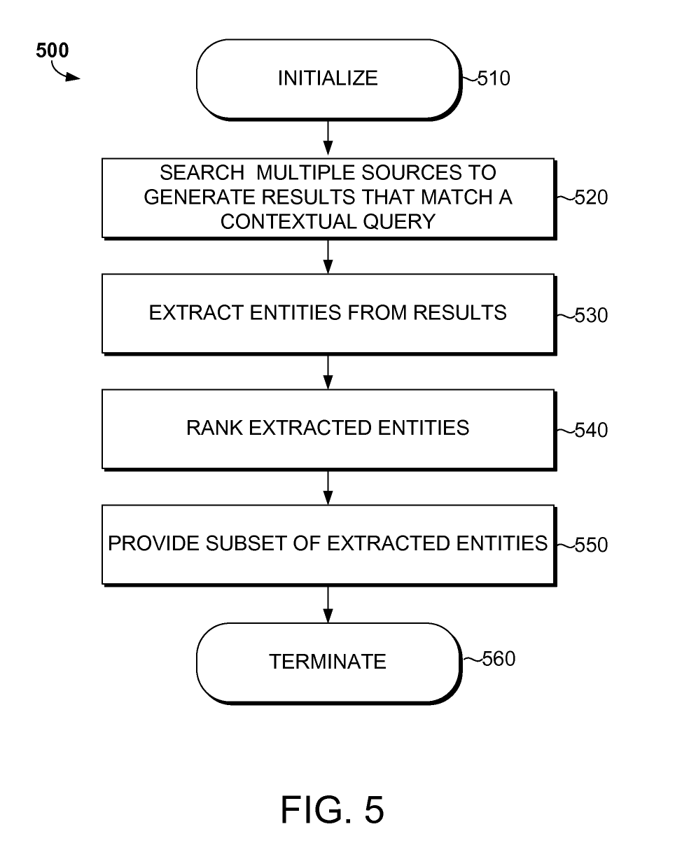

FIG. 5 is a logic diagram 500 illustrating a computer-implemented method for identifying dominant concepts in accordance with embodiments of the invention. The method initializes in step 510 when the search engine receives a contextual query. In an embodiment, the contextual query includes at least two of the following contextual attributes: query terms, location, time, and application.

In step 520, the search engine searches various sources to generate a collection of results that match the contextual query. In turn, entities are extracted from the results based on appearance frequency, in step 530. The appearance frequency may be calculated in several ways. In one embodiment, the appearance frequency is calculated from occurrences within the results. In another embodiment, the appearance frequency is calculated from occurrences within the various sources. In an alternative embodiment, the appearance frequency is the largest of the occurrences within the results and occurrences within the various sources.

In step 540, the extracted entities are ranked based on contextual attributes associated with the contextual query. In one embodiment, the rank of the extracted entities is assigned by accessing a metabase graph. The metabase graph includes nodes and edges. The nodes represent entities. The edges represent the distance between the nodes. Nodes that represent the query terms and the extracted entities are selected. In turn, edges having the distance between the selected nodes are retrieved. The selected nodes representing the extracted entities whose distance to the selected nodes representing the query terms is below the threshold are removed from the selected nodes. In turn, a rank order is assigned to the remaining nodes that represent the extracted entities based on the distance to the selected nodes representing the query terms. In some embodiments, the selected node representing the extracted entity having the smallest distance between the extracted entity and query terms is assigned the largest rank.

The contextual attributes affect the rank assigned to the extracted entities. For instance, a location contextual attribute may affect the rank of extracted entities associated with a location specified in the contextual query by improving the rank assigned to the extracted entities having the specified location when two or more extracted entities are assigned the same rank. Additionally, a date contextual attribute may affect the rank of extracted entities associated with a date specified in the contextual query by improving the rank assigned to the extracted entities having the specified date when two or more extracted entities are assigned the same rank.

In step 550, a subset of the extracted entities with ranks above a dominant concept threshold is provided as dominant concepts for the received contextual query. In one embodiment, the dominant concept threshold is a predefined value. In another embodiment, the dominant concept threshold is selected by a user that formulates the contextual query. The method terminates in step 560.

In some embodiments, the computer systems are configured to identify the relationships between the dominant concepts and the contextual queries for display in response to a user request. The computer system parses the results to locate relationships between the contextual query and the dominant concept. In turn, snippets are selected to support the relationships between the dominant concepts and the contextual query. The snippets are prioritized based on contextual attributes included in the contextual query.

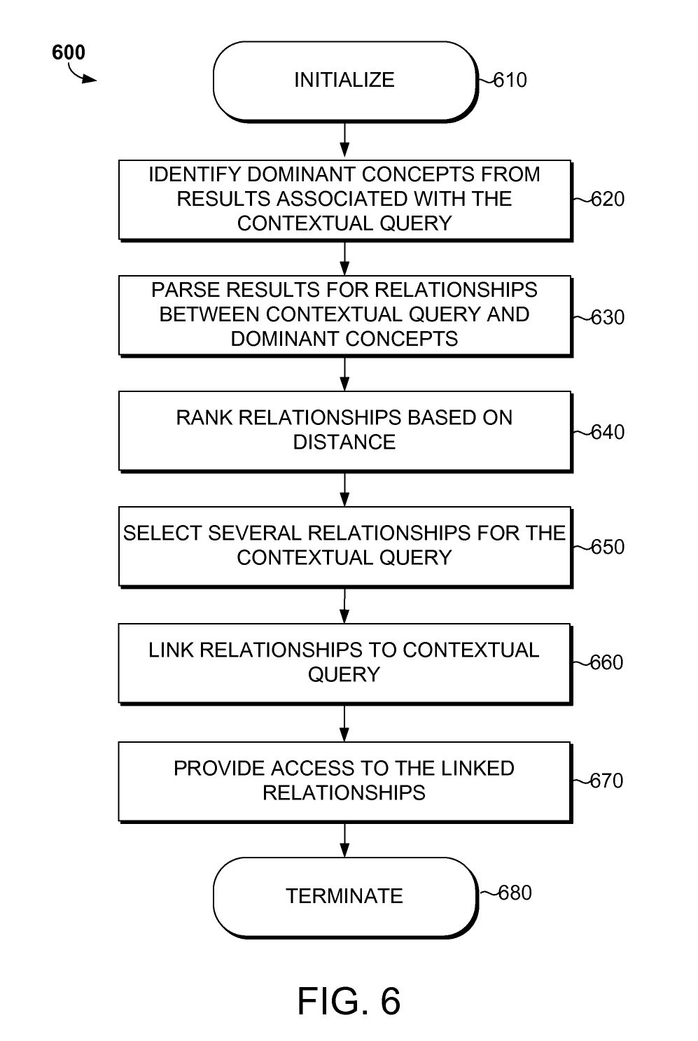

FIG. 6 is another logic diagram 600 illustrating a computer-implemented method for identifying relationships between the dominant concepts and the query terms in accordance with embodiments of the invention. The method initializes in step 610 when the search engine receives the contextual query. In an embodiment, the contextual query includes at least two of the following contextual attributes: query terms, location, time, and application. In step 620, the computer system identifies dominant concepts associated with the contextual query from results generated for the contextual query. The computer system parses the results for relationships between the contextual query and the dominant concepts, in step 630. In certain embodiments, the relationships comprise subjects, objects, and predicates. The subject may represent the contextual attributes of the contextual query. The object may represent the dominant concept. And the predicate may represent the distance between the subject and object.

In step 640, the computer system ranks relationships based on a distance determined from the results. In one embodiment, the computer system may rank each relationship by determining the number of words or characters that separate the contextual query and the dominant concepts. In turn, the computer system may assign a priority to the relationships proportional to the number of words or characters that separate the contextual query and the dominant concepts. Thus, when the number of words or characters is high, the priority assigned to the relationship is low.

The contextual attributes may affect the priority assigned to the relationships. For instance, a location contextual attribute may affect the priority assigned to the relationships associated with a location specified in the contextual query by improving the priority assigned to the relationships having the specified location when two or more relationships are assigned the same priority. Additionally, a date contextual attribute may affect the priority assigned to the relationships associated with a date specified in the contextual query by improving the priority assigned to the relationships having the specified date when two or more relationships are assigned the same priority.

Several of the relationships are selected for the contextual query, in step 650. In step 660, the selected relationships are linked to the contextual query. In step 670, the computer system provides access to the selected relationships via a graphical user interface displaying the results of the contextual query. In one embodiment, the computer system may generate a graph of the dominant concepts and the contextual query for display on the graphical user interface. Additionally, when a user hovers over any of the dominant concepts, the computer system may reveal the relationships associated with the dominant concept and contextual query and a portion, such as a snippet, of the results that supports the relationship. The method terminates in step 680.

In summary, dominant concepts and relationships between the dominant concepts and contextual queries are provided by the computer system. The computer system generates snippets to provide access to the information that supports the relationships. The computer system generates a graphical user interface having a sparkler to provide an overview of the major concepts included in the results.

Many different arrangements of the various components depicted, as well as components not shown, are possible without departing from the spirit and scope of the present invention. Embodiments of the invention have been described with the intent to be illustrative rather than restrictive. It is understood that certain features and subcombinations are of utility and may be employed without reference to other features and subcombinations and are contemplated within the scope of the claims. Not all steps listed in the various figures need be carried out in the specific order described.

The invention claimed is:

1. A computer-implemented method to identify dominant concepts across various sources, the method comprising:
receiving a contextual query;
searching the various sources to generate a collection of results that match the contextual query;
extracting entities from the results based on appearance frequency;
ranking the extracted entities based on contextual attributes associated with the contextual query; and
providing a subset of the extracted entities with ranks above a threshold as dominant concepts for the received contextual query.

2. The method of claim 1, wherein the contextual query includes at least two of the following contextual attributes: query terms, location, time, and application.

3. The method of claim 1, wherein appearance frequency is calculated from occurrences within the results.

4. The method of claim 1, wherein appearance frequency is calculated from occurrences within the various sources.

5. The method of claim 1, wherein ranking the extracted entities based on contextual attributes associated with the contextual query further comprises:
accessing a metabase graph, wherein the metabase graph has nodes that represent entities and edges that represent the distance between the nodes;
selecting nodes that represent the query terms and the extracted entities;
retrieving the distances between the selected nodes;
filtering selected nodes whose distance to the nodes representing the query terms is below the threshold; and
assigning a rank order to remaining nodes that represent the extracted entities based on the distance to the nodes representing the query terms.

6. The method of claim 5, wherein the threshold is a predefined value.

7. The method of claim 5, wherein the threshold is selected by a user that formulates the contextual query.

8. The method of claim 5, wherein the node representing the extracted entity having the smallest distance between the extracted entity and query terms is assigned the largest rank.

9. The method of claim 5, wherein the contextual attributes affect the rank assigned to the extracted entity.

10. The method of claim 9, wherein the location contextual attribute affects the rank of extracted entities associated with a location specified in the contextual query by improving the rank assigned to the extracted entities having the specified location when two or more extracted entities are assigned the same rank.

11. The method of claim 9, wherein the date contextual attribute affects the rank of extracted entities associated with a date specified in the contextual query by improving the rank assigned to the extracted entities having the specified date when two or more extracted entities are assigned the same rank.

12. One or more computer-readable media storing computer-executable instructions to perform a method of selecting relationships between query terms and dominant concepts, the method comprising:
receiving a contextual query;
identifying dominant concepts associated with the contextual query from results generated for the contextual query;
parsing the results for relationships between the contextual query and the dominant concepts;
ranking each relationship based on a distance determined from the results;
selecting several of the relationships for the contextual query;
linking the contextual query with the selected relationships; and
providing access to the selected relationships via a graphical user interface displaying the results of the contextual query.

13. The media of claim 11, wherein the relationships comprise subjects, objects, and predicates.

13. The media of claim 11, wherein subjects are the contextual attributes of the contextual query.

14. The media of claim 13, wherein the contextual query includes at least two of the following contextual attributes: query terms, location, time, and application.

15. The media of claim 12, wherein ranking each relationship based on a distance determined from the results further comprises:
determining the number of words or characters that separate the contextual query and the dominant concepts; and
assigning a priority to the relationships proportional to the number of words or characters that separate the contextual query and the dominant concepts.

16. The media of claim 15, wherein the contextual attributes affect the priority assigned to the relationships.

17. The media of claim 11, wherein hovering over any of the dominant concepts reveals the relationships associated with the dominant concept and contextual query and a portion of the results that supports the relationship.

18. The media of claim 11, further comprising: generating a graph of the dominant concepts and the contextual query.

19. A computer system configured to identify dominant concepts across various sources, the computer system comprising:
a search engine connected to the various sources, wherein the search engine is configured to receive a contextual query and provide results in response to the contextual query;
an entity extraction component configured to parse the results and identify entities included in the results;
a metabase to provide a distance between the entities included in the results and the query terms included in the contextual query; and
a ranking component configured to rank the entities based on distance and select dominant concepts within the results based on the contextual attributes of the contextual query.

20. The system of claim 19, wherein the various sources include videos, images, documents, blogs, news, and audio.
